(19) United States
(12) Patent Application Publication
(10) Pub. No.: US 2004/0149631 A1
(43) Pub. Date: Aug. 5, 2004

(54) Jigging machine

(76) Inventors: Gulnar Ermekova, Karaganda (KZ); Burkit Mainin, Karaganda (KZ); Zhanat Mainina, Karaganda (KZ); Zhibek Mainina, Karaganda (KZ)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/348,667

(22) Filed: Jan. 21, 2003

(51) Int. Cl. B07B 1/00

(52) U.S. Cl. 209/370

(57) ABSTRACT

The invention is in the field of mineral's processing by means of hydraulic jigging and may be used in ore and coal mining as well as some other industries.

Described a jigger, consisting of two traveling troughs, the upper is equipped with a sieve and closed from below by a continuous flexible membrane, the lower is interrelating with the diaphragm of the upper trough, acting as a piston and giving water vertical pulsation. The troughs are hinged jointed between each other via double-arm levers, hinged in the supports. Double-arm levers together with the troughs form a system of hinged parallelogram, providing uniform distribution of pulsation along the whole capacity of the upper trough that produces conditions for the intensification of jigging process. Besides this intensification, decreasing of energy-consumption and simplicity of design having been achieved.

A laboratory sample was made and its testing showed good technological results and confirmed the reliability of unit simple in manufacturing, operating and maintenance.

The invention under discussion is in the field of dressing mineral deposits by the method of hydraulic jigging in the jigging plants and may be used in ore and coal mining as well in some other industries.

### THE PREVIOUS HISTORY OF TECHNIQUE LEVEL

There are jigging plants with traveling sieve, for example, (Directory on ore dressing. Fundamental processes. Moscow “Bowels Publishers. 1983. P. 53-54) the sieve is being given bow-shaped movement with horizontal replacement to the side of loading mineral while the sieve moving downwards and then forward on going upwards. As the result of it the positive effect of simultaneous uprising of all bed and moving of all mineral processed along the sieve is being achieved, the movement control being fulfilled by the replacement of plates with cranks on the movable boards.

The disadvantage of the plant is insufficient loosening of minerals bed in the loading part of the sieve and intermixing of separated fractions as well. Thus, the efficiency of mineral processed is low. Because of this and some other reasons such type of a jigger with traveling sieve didn't find wide application.

As a prototype for our invention was used a jigger “The WEMCO REMER JIG (Samylinma, Zolatco AA, Pochinok VV. Jigging/Moscow Bowels Publishers. 1976 p. 202). The device has an upper untravelling trough with sieve and lower travelling one; they are connected by rubber diaphragm along perimeter. The lower sieve is being given vertical reciprocating movement by means of special doubled eccentric mechanism. As a result, vertical pulsation of under—sieve water has been achieved that is very important for jigging process.

The disadvantage of the prototype are the complexity of the design due to the eccentric unit, high inertiability of the lower part of the plant and as the result of it high energy-consumption because of the fact that each stage of jigging reguires uprising of the lower trough with the whole quantity of water; low efficiency of jigging process as there is no accurate simultaneous uprising of the whole bed that is characteristic to the jiggers with untravelling trough.

### THE ESSENCE OF THE INVENTION

The technical purpose of the invention is designing a jigger simple in construction but with intensive and low energy-consuming jigging process.

We offer a jigger with two traveling troughs hinged by double-arm levers, the upper having a sieve inside with continuous flexible membrane in the lower part, interacting with the lower trough. The double-arm levers are hinged with supports. Reciprocating movement of troughs is being provided by setting driving gear in the centre of rotation axel of double-arm levers, for example, centre weir rotating hydro engine. As a result, reciprocating movement of troughs is being given both vertically-for jigging process and horizontally—for transporting mineral processed to the place of unloading out of the jigger.

In the case the design is simplified because the lower trough performs the function of a piston producing pulsation of the under-sieve water vertically. The double-arm levers together with the troughs form a system of hinged parallelogram, that provides uniform pulsation of the under-sieve water along the whole capacity of the upper trough and produces conditions for intensification of jigging process.

Synchronically with the lower trough's traveling downwards there is a replacement of the upper trough with sieve upwards, that provides simultaneous uprising of the whole bed. It is very important for the efficiency of jigging process and the usage of jiggers with traveling trough proved it/Bent P.O. Technology of gravitational processing. Translation from English/Moscow, Bowels Publishers, 1990 p 219-220.

While the upper trough with the sieve travels downwards the lower one synchronically travels upwards and acting upon membrane produces vertical pulsation of the under-sieve water, that is also very important for jigging process.

In one unit two advantages of jiggers with traveling and untravelling sieve have been realized because of intensification of the jigging process. High efficiency of the forced efforts-namely, driving gear's effort—is being achieved; consequently energy-consumption of the jigging process is less and due to matching masses of upper and lower troughs, water quantity in the upper trough and mass of mineral processed it's possible to get a system wholly balanced cinematically.

### SHORT DESCRIPTION OF DRAWINGS

FIG. 1—the scheme of jigger, side-view,

FIG. 2 cross-cut AA on FIG. 1;

FIG. 3—cinematic scheme of jigger /F1=F2—the condition for the balance of the system, where F1 and F2—efforts, produced by masses of the upper trough with sieve, lower trough, mineral processed and water 1/.

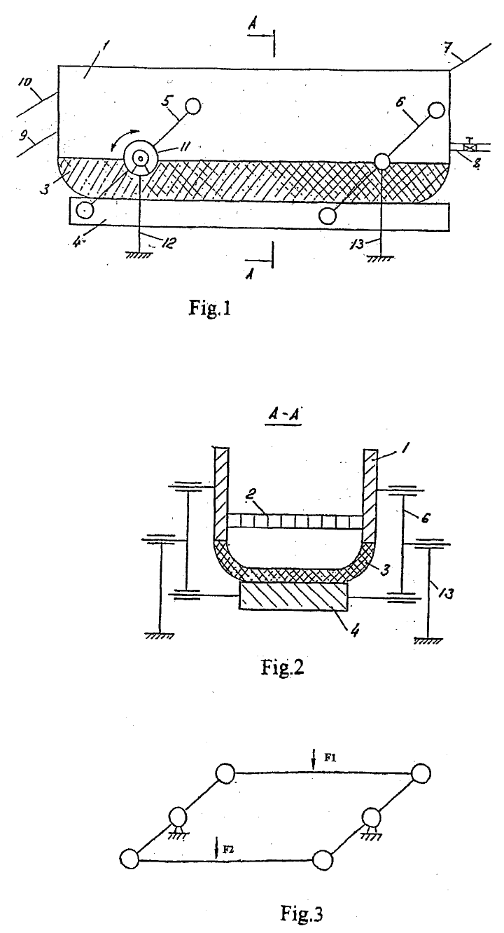

### VARIANTS OF REALIZATION OF THE INVENTION

The jigger under discussion has upper trough 1 with untravelling sieve 2 that is closed from below by flexible membrane 3; lower trough-piston 4, interrelating with the flexible membrane and hinged with upper trough 1 and double-arm levers 5 and 6 with the help for example, antifriction bearing; double-arm levers are at the front and end parts of troughs 1 and 2. On the back butt-end of upper trough 1 there is a loading unit 7, water via flexible hoses 8 is being forced under sieve 2, unloading of processed products being performed through unloading units 9 and 10, that are located on the front butt-end of trough 1. Troughs are being activated by driving gear 11. Double-arm levers 5 and 6 are hinged with supports 12 and 13.

The jigger operates in the following way; mineral to be processed is being given to upper trough 1 out of loading unit 7. Driving gear 11 forces troughs 1 and 4 move reciprocatingly. Synchronically with traveling lower trough 4 downwards upper trough 1 with sieve 2 travels upwards that results in uprising of the whole bed. On traveling upper trough 1 with sieve 2 downwards lower one 4 synchronically travels upwards and acting upon flexible membrane 3 produces vertical pulsation of the under-sieve water. The products of processing are being delivered out through unloading units 9 and 10. Loss of water while unloading is being compensated by permanent provision of water through hose 8.

### INDUSTRIAL IMPLEMENTATION

The multi-functionality of the invention is additional technical advantage, the possibility of using it as a transport vehicle, moreover transporting is being performed along the inclined upwards; then taking away the flexible membrane and installing the sieve with appropriate size of holes it is possible to use if for classifying mineral according to coarseness.

Cinematic scheme of the device permits to increase the unitary capacity of jigger by means of simple increasing linear measurements both in width and length without making the plant's construction complex. Using revolving hydroengine as a driving gear gives the possibility to regulate efficiently two most important parameters of the jigging process-amplitude and frequency of pulsation without the jigger's stop.

A laboratory sample of the jigger was made and its testing showed positive technological results in jigging and also confirmed the reliability of the device, simplicity of design, manufacturing and maintenance. At present the work is in the progress to manufacture a device for trial industrial usage.

Thus, constructive differences of the jigger offered permit to solve technological task; intensification of jigging process without losing quality, decreasing of energy consumption, simplifying the jigger's construction and certainly these differences are of great importance. As we think, the present differences give up-to-date technological level to the device. And its industrial usage is beyond any hesitation.

1. Jigger with upper trough a sieve inside, lower trough, driving gear, devices for mineral's loading, water delivery and unloading the products processed, characterizing by the upper trough being equipped below with continuous flexible membrane interacting with lower trough, and moreover troughs are being hinged by double-arm levers, hinged on supports.
